(19) United States
(12) Patent Application Publication
(10) Pub. No.: US 2006/0084050 A1
(43) Pub. Date: Apr. 20, 2006

(54) Portable virtual reality medical demonstration and training apparatus

(76) Inventor: Randy S. Haluck, Lititz, PA (US)

Correspondence Address: GIFFORD, KRASS, GROH, SPRINKLE & CITKOWSKI, P.C, PO BOX 7021, TROY, MI, 48007-7021, US

(21) Appl. No.: 11/033,073

(22) Filed: Jan. 11, 2005

Related U.S. Application Data
(60) Provisional application No. 60/535,924, filed on Jan. 12, 2004.

(51) Int. Cl. G09B 23/28; G09B 25/00

(52) U.S. Cl. 434/365; 434/262

(57) ABSTRACT

A training apparatus presents a virtual environment to a user and allows the user to interact with the virtual environment. The training apparatus includes a base, an interface and a tool. The base has a storage device and a central processing unit. The interface may provide haptic feedback responsive to interaction between the user and the virtual environment. The tool is operatively coupled to the interface, by which the user interacts with the virtual environment, and through which haptic feedback may be provided to the user from the interface. The tool has storage for software code that forms an application defining the virtual environment.

### REFERENCE TO RELATED APPLICATION

This application claims priority of U.S. Provisional Patent Application Ser. No. 60/535,924 filed Jan. 12, 2004, which is incorporated herein by reference in its entirety.

### STATEMENT OF GOVERNMENT RIGHTS

The invention described herein was made with Government support under Contract No. N00014-03-1-0863 awarded by the Office of Naval Research. The United States Government has certain rights in this invention.

### FIELD OF THE INVENTION

The present invention relates to simulation training platforms. More particularly, the invention relates to a portable simulation training platform that is convertible to provide simulation training and demonstration within a variety of simulated environments.

### BACKGROUND OF THE INVENTION

It is appreciated that extensive training is commonly required to become skillful at procedures using hand instruments or controls for a number of applications in medicine, industry, aerospace, and the military. These procedures include performing simple and complex medical and surgical procedures, understanding the workings and assembly of devices, tools, weapons and machinery, and performing various tasks associated with manufacturing processes. Many procedures of this type require specific dexterity and working knowledge of a specific tool that may be acquired through actual hands-on training or via simulation devices.

Some devices for training an individual in the use of such tools are typically introduced to the trainee in a classroom or live setting which may be high risk and/or expensive. Many simulators of this type never reach the market due to high development costs, limited profit margins, and the proprietary nature of such devices.

U.S. Pat. No. 5,766,016 provides a training simulator for simulating surgical procedures. The simulator provides both visual and tactile feedback in order to realistically portray an actual surgical procedure. The visual feedback is provided through an SGI graphics computer which drives a display monitor. An instrument for simulating a surgical tool is in communication with a plurality of servo-motors which collectively generate a resistive force along several directions to provide tactile feedback. Although the training device provided by the '016 reference appears to be adequate for demonstrating and/or training an individual in a particular task or procedure, the development cost of such an application specific device in view of the prospective market may prevent such a device from being brought to market and successfully commercialized. Additionally, the concept disclosed therein is not capable of being converted to facilitate simulation training for a variety of tasks or procedures that could operate to increase its commercial appeal.

The present invention seeks to provide a low cost, multipurpose simulation training device in a highly portable package that supports the interchangeability of a variety of simulation training applications.

### SUMMARY OF THE INVENTION

According to one aspect of the invention, a training apparatus is provided for allowing a user to interact with a virtual environment. The training apparatus includes a base, an interface and a tool. The base has a storage device and a central processing unit. The interface provides haptic feedback responsive to interaction between the user and the virtual environment. The tool is operatively coupled to the interface, by which the user interacts with the virtual environment, and through which the haptic feedback is provided to the user from the interface. The tool has in storage therewith a software code that forms an application defining the virtual environment.

According to another aspect of the invention, a medical training apparatus is provided for allowing a user to interact with a virtual environment. The training apparatus includes a base, an interface and a plurality of tools. The base has a storage device and a central processing unit. The interface provides haptic feedback responsive to interaction between the user and the virtual environment. The plurality of tools each simulates a different instrument used in a medical setting. Each of the plurality of tools is releasably connectable to the interface. Each of the tools has in storage therewith a unique software code that forms an application defining the virtual environment in a manner specific to each of the plurality of tools.

### BRIEF DESCRIPTION OF THE DRAWINGS

Advantages of the present invention will be readily appreciated as the same becomes better understood by reference to the following detailed description when considered in connection with the accompanying drawings, wherein:

FIG. 1 is a perspective view of a training apparatus according to an embodiment of the invention;

FIG. 2 is a perspective view of a tool for training a user of the training apparatus in the use of a syringe;

FIG. 3 is a perspective view of a tool for training the user in the use of a laparoscopic device;

FIG. 4 is a schematic view of the training apparatus of FIG. 1;

FIG. 5 is a perspective view of a tool according to an alternative embodiment of the invention for training the user in the use of a syringe; and

FIG. 6 is a perspective view of a tool according to an alternative embodiment of the invention for training the user in the use of a laparoscopic device.

### DETAILED DESCRIPTION OF THE INVENTION

The present invention provides a portable virtual reality instrument training and demonstration apparatus that has the ability of providing simulations for a wide variety of tools used in a medical setting. The inventive concept has the ability to move simulation training out of the lab and into the healthcare practice site, the battlefield, or the industrial workplace by presenting a portable, virtual environment to a user. The user can then interact with the virtual environment with tools designed to simulate tools used in the medical setting. The apparatus has the capability to promote real-time or just-in-time training for various users and is built on a portable, flexible, and versatile platform that has several advantages over conventional simulation platforms that are relatively bulky, task specific and designed to provide instruction in only one or a few related procedures.

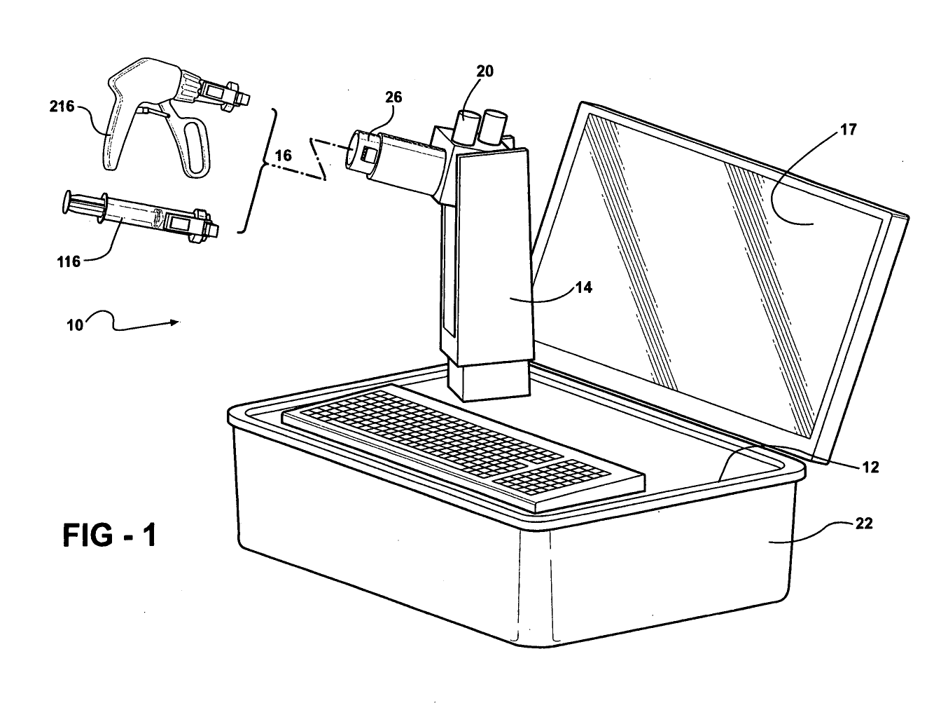

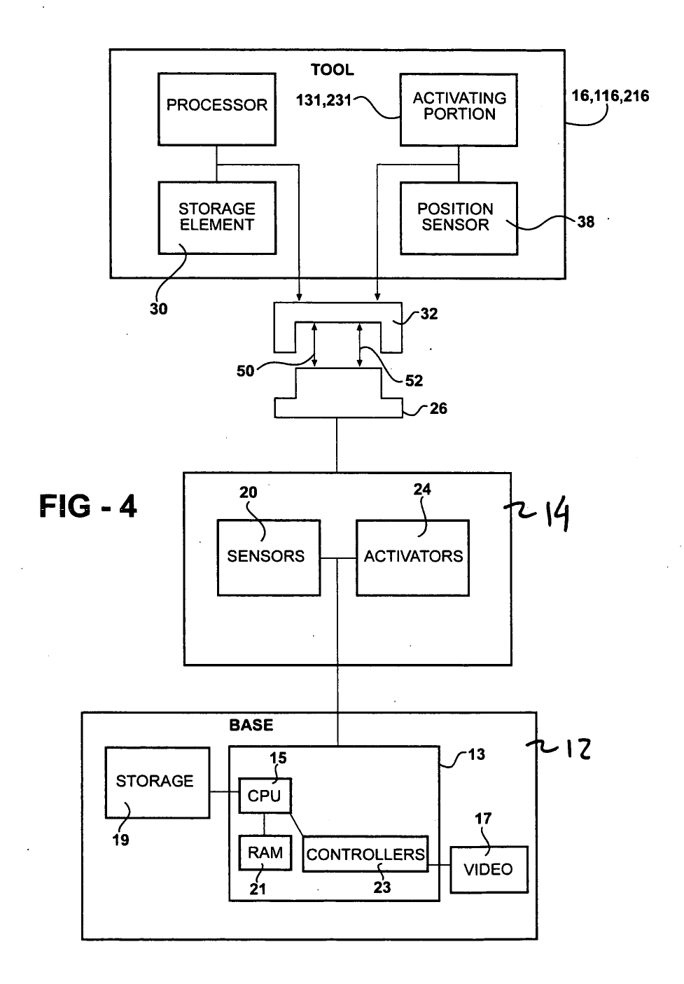

Referring to FIGS. 1-4, the training apparatus is generally indicated at 10. The apparatus includes a portable base 12, an interface 14, at least one user interface or tool 16, an on-board video display 17 and a power supply 18. Generally, the base 12 provides a means for executing an application defining a virtual environment. The virtual environment is presented on the display 17. The interface 14 and the tool 16 allow the user to interact with the virtual environment shown on the display 17. Optionally, the base unit 12 is provided with a proper interface for connecting to an external monitor or other device that provides a visual interface for the apparatus 10 or extends the virtual field provided by the on-board video display 17.

More specifically, the base 12 includes a mother board 13 operatively supporting temporary or random access memory (RAM) 21, a central processing unit (CPU) 15, a rewritable storage device 19, controllers 23 (e.g. video cards and other component accelerators), and a plurality of input and output modules or ports for connecting peripheral devices (e.g. the interface 14, the tool 16), a wireless communication device (e.g. 802.11b, Bluetooth) or other suitable means for interfacing with conventional networks such as the internet, intranet, local networks or similar systems and/or devices. The base 12 also includes an operating system resident on the storage device 19 for controlling the overall function of the base 12.

The interface 14 is provided in communication between the tool 16 and the base 12. More specifically, the interface 14 includes at least one position sensor 20 to sense and provide data relating to the position of the tool 16 relative to at least one axis. Preferably, a plurality of position sensors 20 are utilized to sense position along a plurality of axes defining six degrees of freedom. The position sensors 20 are further operative to send position data to the CPU 15 of the base 12. The CPU 15 utilizes the position data to determine changes in position of the tool 16 along the axes. The CPU 15 causes corresponding changes in the position of the tool 16 as it is depicted in the virtual environment. It is appreciated that the interface 14 provides for bidirectional data communication between the base 12 and the user interface 16. Preferably the interface 14 includes a standard connector 26 that allows connection to various user interfaces 16 or tools to obviate the need for additional coupling hardware. The standard connector 26 is coupled to the motherboard via conventional wiring, wherein each wire terminates in a respective pin-receiving aperture at the end of the standard connector 26. However, it is appreciated that certain modifications may be made to the interface 14 to facilitate the coupling between two or more user tools in order to better simulate the demonstration or training environment.

Optionally, the interface 14 includes a plurality of actuators 24 that provide real-time haptic or force feedback to the user during the demonstration or training session in response to interaction between the user, the tool as depicted in the virtual environment and objects that may be shown in contact with the tool within the virtual environment. Real-time means that force is applied by the interface 14 as an application of force is depicted in the virtual environment. The actuators 24 may be of any suitable type known by those having ordinary skill in the art, such as a hydraulic, motor and gear driven or gyroscopic type device.

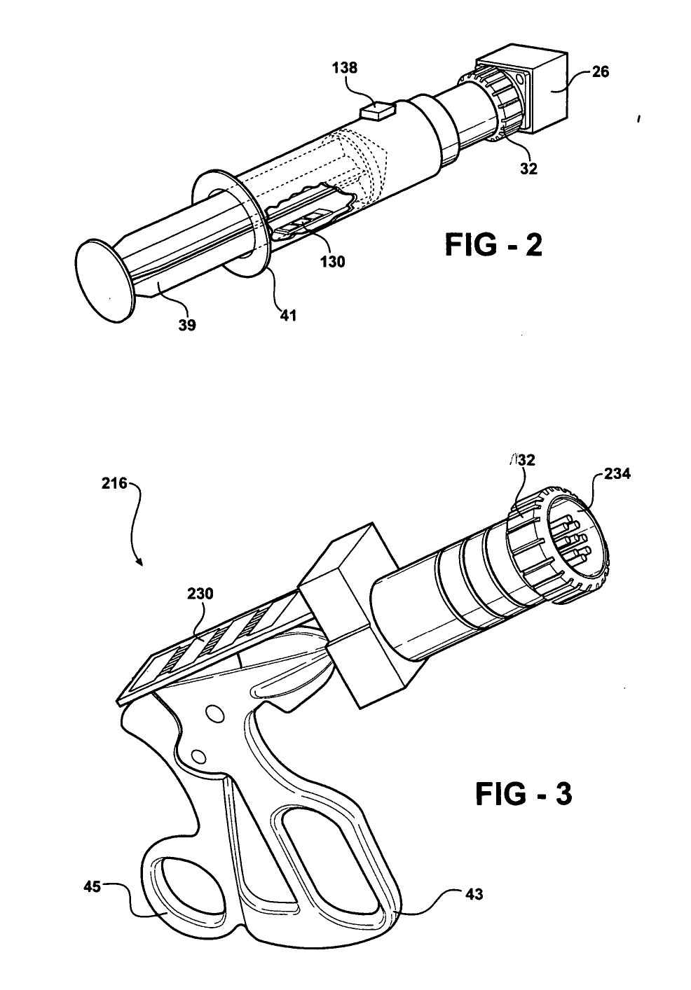

The training apparatus 10 may include a plurality of tools 16. Each tool 16 simulates a different instrument used in a medical setting. Two such tools 16, a syringe tool 116 and a surgical or laparoscopic tool 216, are shown in greater detail in FIGS. 2 and 3, respectively, wherein like parts are indicated by reference characters offset by 100. Each tool 16 includes a storage or memory element 30 for storing software code that forms an application defining the virtual environment in a manner specific to each tool 16. The memory element 30 also stores driver information that is unique to each tool 16 and allows the processor unit to learn or recognize the tool 16 upon connection with the interface 14. The storage element 30 can be in the form of code programmed on a chip or stored on a conventional storage medium, such as a hard drive, solid state memory or other suitable means known by those having ordinary skill in the art. The tool 16 is operative upon connection to the interface 14 to download at least a portion of the software application to the storage device 19 of the base 12, and to launch a portion of the application code directing the CPU 15 to execute the application therefrom.

Additionally, each tool 16 is disposed with a unique software application and the physical attributes of the tools 20 needed in the simulated environment are adapted to imitate the actual tools as closely as possible to optimize the demonstration or training experience. In this manner, a variety of simulated training environments may be provided with the apparatus 10 simply by interchanging the hand tool 16. Optionally, the tool 16 can include an on-board processor for executing the application from the tool 16 itself. Optionally, the tool may include a processor for managing the storage element 30 in a manner similar to portable storage devices, such as thumb drives and flash drives, so that the storage element 30 can operate as a secondary storage from which the CPU 15 can directly execute the application. Optionally, the application may also be launched and run from a combination of the base 12 and tool 16.

The tool 16 may also store user specific data, such as personal preferences, training history, and performance. The user specific data is then readily transferable between different base units 12, such that the base unit 12 may be readily and effectively individualized to the user's preferred specification upon connection of the tool 16 therewith. Accordingly, the base 12 of the inventive apparatus does not require any previous installations of applications and drivers related to the tool 16. All the necessary application code, driver information and user specific data is preferably disposed within the tool 16 for downloading to the base 12.

Each tool 16 includes an actuating portion 131, 231 adapted to simulate a portion of the medical tool that is directly actuated by a hand of the user. In FIG. 2, the actuating portion 131 of the syringe tool 116 includes a plunger 39 and a syringe barrel 41. The plunger 39 and syringe barrel 41 are preferably constructed in substantially the same manner as an actual syringe used in the medical setting. The memory element 130 is disposed in a space defined between the plunger 39 and the barrel 41.

In FIG. 3, the actuating portion 231 of the laparoscopic tool 216 includes a fixed handle 43 and an actuated handle 45 pivotally coupled thereto. The fixed 43 and actuated 45 handles are constructed in substantially the same manner as an actual laparoscopic tool used in the medical setting. The memory element 230 is disposed along a top surface of the laparoscopic tool.

Each tool 116, 216 includes a connector end 32 adapted to engage the standard connector 26 of the interface 14. Preferably, the connector end 32 is the same across the various tools 116, 216 to allow use of the same standard connector 26 on the interface 14. The memory element 30 is coupled to the connector end 32 by a wire, as known by those of ordinary skill in the art. The wires terminate at respective pins 134, 234 in the connector end 32. The pins 134, 234 enter respective pin-receiving apertures in the standard connector 26 to form a data link between the memory element 30 and the motherboard upon connection of the connector end 32 to the standard connector 26. Further, the standard connector 26 and the connector end 32 are selectively coupled together in a male/female-type arrangement to define a substantially rigid mechanical connection. Thus, the tool 116, 216 is releasably connectable to the interface 14 to define both a mechanical connection 50 and a data connection 52. The mechanical connection allows haptic feedback to be provided from the interface 14 to the user and allows mechanical user input to be provided from the user to the interface 14 via the tool 116, 216. The data connection allows preferably bi-directional communication between the tool 116, 216, the interface 14 and the base 12.

Upon connection of the tool 116, 216 to the interface 14, the code and driver information is automatically downloaded from the memory element 30 to the storage device 19 in the base 12. Further, the code includes a set of instructions directing the processing unit of the base 12 to automatically launch the application upon connection of the tool 116, 216 to the interface 14.

Each tool 116, 216 also includes a position sensor 38 to provide data to the processing unit relating to the extent of actuation of the tool 116, 216. More specifically, in FIG. 2, the position sensor 38 is a slide or linear potentiometer sensor for sensing linear displacement of the plunger 39 relative to the syringe barrel 41. In FIG. 3, the position sensor (not shown) is a linear sensor sensing a tangential component of the pivotal movement between the fixed 43 and actuated 45 handles. Optionally, a rotary potentiometer may be used for sensing the pivotal movement of the actuated handle 45 relative to the fixed handle 43. The processing unit uses the data provided by the position sensor 38 to cause corresponding displacement of the tool 116, 216 as it is generated in the virtual environment shown on the video display 17. The position sensor 38 may be of any suitable type known in the art, such as linear and rotary potentiometers.

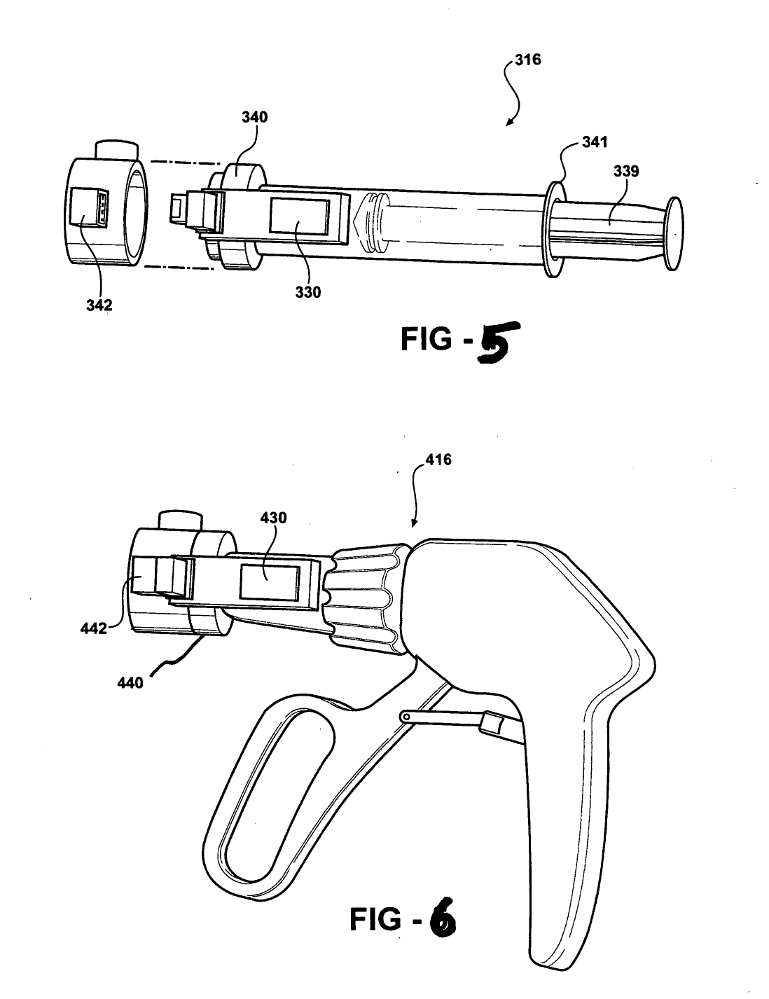

In FIGS. 5 and 6, alternative embodiments of syringe and laparoscopic tools 316, 416 are shown. Each tool 316, 416 includes a standard male-female mechanical connector 340, 440 to form the mechanical connection. A Universal Serial Bus or USB connector 342, 442 is fixedly secured to the mechanical connector 340, 440, such that the mechanical and data connections are formed at substantially the same time, as in the previous embodiment.

The components of the base 12 may be provided in the form of components from a standard personal computer. For example, the CPU may be based on an Intel, AMD or Motorola based chip. The storage device may be a standard hard drive, such as those produced by LaCie, Western Digital or Maxtor. And, the graphics accelerator may be of any type suitable for handling the graphics typical of a virtual reality environment, such as those produced by Nvidia, ATI or Diamond. Thus, utilizing standard personal computer components within the base 12 allows upward or downward scalability to accommodate varying levels of complexity of the virtual environment and budget allotted for the production of the training apparatus. The central processing unit, storage device, graphics accelerator, and mother board may also be part of a standard or custom computer, such as a laptop or portable computing device. The interface may be provided in the form of a conventional gimbal input system having any suitable degrees of freedom depending on the application.

Preferably, the entire training apparatus 10 is supported in a closeable case having a box-shaped lower portion and a lid hinged thereto. Seals are provided between the lower portion and the lid to prevent moisture from entering the case. Most preferably, the case is made from a durable, weather resistant material such as glass reinforced nylon, or other suitable conventional materials.

The invention has been described in an illustrative manner. It is, therefore, to be understood that the terminology used is intended to be in the nature of words of description rather than of limitation. Many modifications and variations of the invention are possible in light of the above teachings. Thus, within the scope of the appended claims, the invention may be practiced other than as specifically described.

I claim:

1. A training apparatus for allowing a user to interact with a virtual environment, the training apparatus comprising:
a base, an interface, and a tool;
the base having a storage device and a central processing unit;
the interface operatively coupled between the base and the tool to allow interaction between the user and the virtual environment; and
a tool operatively coupled to the interface, by which the user interacts with the virtual environment, the tool including software storage with software code stored therein, the software code operative to form an application defining the virtual environment.

2. A training apparatus as set forth in claim 1, wherein the tool is operable for automatically downloading at least a portion of the software code from the storage element to the storage device of the base upon connection of the tool to the interface.

3. A training apparatus as set forth in claim 2, wherein the tool is operable to automatically download and launch a set of instructions directing the processing unit to execute the application upon connection of the tool to the interface.

4. A training apparatus as set forth in claim 1, wherein the tool is releasably connectable to the interface for both a mechanical connection to be provided between the interface and the user via the tool and a data connection allowing data sharing between the tool, the interface and the base.

5. A training apparatus as set forth in claim 1, wherein the tool includes storage for driver information executable by the processing unit to allow the processing unit to recognize the tool upon connection with the interface.

6. A training apparatus as set forth in claim 5, wherein the tool is operable to automatically download and install the driver information to the storage device of the base so that the processing unit recognizes the tool upon connection of the tool with the interface.

7. A training apparatus as set forth in claim 1, wherein the interface provides haptic feedback to the user in response to interaction between the user and the virtual environment.

8. A medical training apparatus for allowing a user to interact with a virtual environment, the training apparatus comprising:
a base having a storage device and a central processing unit;
an interface operatively coupled to the base and the tool to allow interaction between the user and the virtual environment; and
a plurality of tools each simulating a different instrument used in a medical setting, each of the plurality of tools being releasably connectable to the interface so as to operatively couple the tool to the base thru the interface, each of the tools having storage for a unique software code that forms an application defining the virtual environment in a manner specific to each of the plurality of tools.

9. A medical training apparatus as set forth in claim 8, wherein the interface if further operative to provide haptic feedback to the user in response to interaction between the user and the virtual environment.

10. A medical training apparatus as set forth in claim 9, wherein the tools are releasably connectable to the interface by a standardized male and female arrangement providing both a mechanical connection allowing the haptic feedback to be provided between the interface and the user via the tool and a data connection allowing data sharing between the tools, the interface and the base.

11. A training apparatus as set forth in claim 8, wherein each of the plurality of tools is operable for automatically downloading at least part of the software code to the storage device of the base upon connection of each of the plurality of tools to the interface.

12. A training apparatus as set forth in claim 8, wherein each of the plurality of tools is operable to automatically download and launch a set of instructions directing the processing unit to execute the application upon connection of each of the plurality of tools to the interface.

13. A method of training comprising the steps of:
providing a base having a storage device and a central processing unit;
providing an interface operatively coupled to the base and the tool to allow interaction between a user and a virtual environment;
providing a tool operatively coupled to the interface, by which the user interacts with the virtual environment;
providing in storage with the tool a software code that forms an application defining the virtual environment;
coupling the tool to the interface to form both a mechanical connection allowing feedback between the tool and the interface and a data connection allowing transfer of data between the tool and the base; and
training a user in the use of the tool within the context of the virtual environment defined by the application.

14. A method of training as set forth in claim 13, wherein the interface is further operative to provide haptic feedback responsive to interaction between a user and the virtual environment, and the training step includes providing haptic feedback to the user through the tool and the interface.

15. A method of training as set forth in claim 13, further including the step of automatically downloading at least a portion of the software code to the storage device of the base upon connection of the tool to the interface.

16. A method of training as set forth in claim 13, further including the step of automatically downloading and launching a set of instructions directing the processing unit to execute the application upon connection of the tool to the interface.

17. A method of training as set forth in claim 13, further including the step of providing a plurality of tools each simulating a different instrument used in a medical setting.

18. A method of training as set forth in claim 17, further including the step of automatically launching an application defining the virtual environment in a manner specific to each tools upon connection of each tool with the interface.

19. A training tool for training a user in the use of a medical tool, the training tool comprising:
an actuating portion adapted to simulate a portion of a medical tool that is directly actuated by a hand of the user;
a position sensor operatively coupled to the actuation portion to sense and provide position data relating to the extent of actuation of the actuating portion of the tool; and
a memory element that provides storage for a software code that forms an application defining the virtual environment.

20. A training tool as set forth in claim 19, wherein the actuating portion includes a cylindrical barrel and a plunger slidably supported within the barrel to simulate a syringe.

21. A training tool as set forth in claim 20, wherein the memory element is disposed within a space defined between the barrel and plunger.

22. A training tool as set forth in claim 19, wherein the actuating portion includes first and second handles pivotally coupled to each other to simulate a laparoscopic device.

23. A training apparatus for training a user in the use of a medical device, the training apparatus comprising:
a storage device;
a processor connected to the storage device;
a tool adapted to simulate the medical device, the tool having a storage element;
an interface operatively coupled between the tool and the processor to allow input from the user to the processor via the tool; and
a software code that is executable by the processor to form an application, the application defining a virtual environment, the virtual environment providing a context within which the user is trained in the use of the medical device, the software code being stored on the storage element of the tool.

24. A training apparatus as set forth in claim 23, wherein the tool is operable for automatically downloading at least a portion of the software code from the storage element to the storage device upon connection of the tool to the interface.

25. A training apparatus as set forth in claim 24, wherein the tool is operable to automatically download and launch a set of instructions directing the processor to execute the application upon connection of the tool to the interface.

26. A training apparatus as set forth in claim 23, wherein the tool is releasably connectable to the interface for both a mechanical connection allowing the haptic feedback to be provided between the interface and the user via the tool and a data connection allowing data sharing between the tool, the interface and the base.

27. A training apparatus as set forth in claim 23, wherein the interface provides haptic feedback to the user responsive to interaction between the user and the virtual environment.
